(19) United States
(12) Patent Application Publication
(10) Pub. No.: US 2018/0310119 A1
(43) Pub. Date: Oct. 25, 2018

(54) COMMUNICATION SYSTEM, SERVER, WEARABLE DEVICE, USER TERMINAL, AND CONTROL METHOD THEREOF

(71) Applicant: Samsung Electronics Co., Ltd., Suwon-si, Gyeonggi-do (KR)

(72) Inventors: Ju-ho HYUN, Suwon-si (KR); Jae-chul YANG, Anyang-si (KR); Yu-sin JUNG, Seoul (KR); Hyun-jong ROH, Suwon-si (KR); Sang-ha PARK, Seoul (KR)

(21) Appl. No.: 15/763,303

(22) PCT Filed: Sep. 29, 2016
(86) PCT No.: PCT/KR2016/010888

§ 371 Date: Mar. 26, 2018

Related U.S. Application Data
(60) Provisional application No. 62/236,517, filed on Oct. 2, 2015.

(30) Foreign Application Priority Data
Dec. 3, 2015 (KR) 10-2015-0171619

(51) Int. Cl. H04W 4/02; H04B 1/3827

(52) U.S. Cl. CPC H04W 4/02; H04W 4/80; H04B 1/385

(57) ABSTRACT

A control method of a server is provided, the method including receiving data which a wearable device obtains via near-field communication, from the wearable device, obtaining context information of the wearable device using the received data and generating a UI element corresponding to the context information of the wearable device, and transmitting the context information of the wearable device and the UI element to a user terminal.

### TECHNICAL FIELD

The present disclosure relates to a communication system, a server, a wearable device, a user terminal, and a control method thereof, more particularly, to a communication system which provides context information of a wearable device to a user terminal, a server, a wearable device, a user terminal, and a control method thereof.

### BACKGROUND ART

The people who raise a pet have increased for various reasons such as a decrease in number of family members living together, etc. A pet is regarded as a companion animal which people share a life with, not simply an animal which people raise. Accordingly, the pet-related industry has been growing, and a variety of devices and services for a person and a companion animal have been introduced in the IT industry.

Most of the current pet-related techniques are a unidirectional technique which monitors the state of a pet staying alone in the house, and there has been a problem that if an emergency situation occurs to a pet, the situation of the pet cannot be informed to the owner. Therefore, there has emerged the need for the method of bidirectional communication between an owner and a pet even in the situation where the owner stays far from the pet.

### DETAILED DESCRIPTION FOR THE INVENTION

### Problem to Solve

An aspect of example embodiments relates to providing a control method of a user terminal and a communication system for obtaining context information of a wearable device and providing a UI element which corresponds to the context information.

### Means to Solve the Problem

According to an example embodiment, a control method of a server is provided, the method including receiving data which a wearable device obtains via near-field communication, from the wearable device, obtaining context information of the wearable device using the received data and generating a UI element corresponding to the context information of the wearable device, and transmitting the context information of the wearable device and the UI element to a user terminal.

The generating a UI element may include obtaining position information of the wearable device and information regarding time for which the wearable device stays in the position using the received data, and generating a UI element corresponding to the position information and the time information.

A certain command may be transmitted to the wearable device in response to the obtained context information of the wearable device satisfying a predetermined condition.

The transmitting a certain command may include transmitting to the wearable device a command for connecting a video call to the user terminal in response to the wearable device being positioned in a predetermined area or being positioned in a same area for a predetermined period of time or more.

The method may further include receiving a user command for controlling at least one of the wearable device and a camera from the user terminal, and transmitting the user command to the wearable device.

The generating a UI element may include obtaining context information of the wearable device and generating a UI element which accumulates the context information for a predetermined period of time and indicates the accumulated context information.

The receiving may include receiving a voice signal input in the wearable device from the wearable device, and the generating a UI element may include obtaining context information of the wearable device using the received voice signal and generating a UI element corresponding to the context information of the wearable device.

The transmitting may include transmitting the obtained context information of the wearable device and the UI element to the user terminal in response to the obtained context information of the wearable device satisfying a predetermined condition.

According to an example embodiment, a server is provided, the server including a communicator configured to communicate with a wearable device and a user terminal, and a controller configured to control the communicator to receive data which the wearable device obtains via near-field wireless communication, from the wearable device, obtain context information of the wearable device using the received data and generate a UI element corresponding to the context information of the wearable device, and control the communicator to transmit the context information of the wearable device and the UI element to the user terminal.

The controller may obtain position information of the wearable device and information regarding time for which the wearable device stays in the position using the received data.

The controller may control the communicator to transmit a certain command to the wearable device in response to the obtained context information of the wearable device satisfying a predetermined condition.

The controller may control the communicator to transmit to the wearable device a command for connecting a video call to the user terminal in response to the wearable device being positioned in a predetermined area or being positioned in a same area for a predetermined period of time or more.

The controller may control the communicator to receive a user command for controlling at least one of the wearable device and a camera from the user terminal and to transmit the user command to the wearable device

The controller may obtain context information of the wearable device and generate a UI element which accumulates the context information for a predetermined period of time and indicates the accumulated context information.

The controller may receive a voice signal input in the wearable device from the wearable device, obtain the context information of the wearable device using the received voice signal, and generate a UI element corresponding to the context information of the wearable device.

The controller may control the communicator to transmit the obtained context information of the wearable device and the UI element to the user terminal in response to the obtained context information of the wearable device satisfying a predetermined condition.

According to an example embodiment, a control method of a communication system is provided, the method including obtaining data using near-field wireless communication by a wearable device, transmitting the obtained data to a server by the wearable device, obtaining context information of the wearable device using the received data and generating a UI element corresponding to the context information of the wearable device by the server, transmitting the context information of the wearable device and the UI element to a user terminal by the server, and displaying the received context information and the UI element by the user terminal.

According to an example embodiment, a control method of a communication system is provided, the method including obtaining a voice signal by a wearable device, transmitting the obtained voice signal to a server by the wearable device, obtaining context information of the wearable device using the received voice signal and generating a UI element corresponding to the context information of the wearable device by the server, transmitting the context information of the wearable device and the UI element to a user terminal by the server, and displaying the received context information and the UI element by the user terminal.

### Effect of Invention

According to the various example embodiments, a user may be provided with context information of a wearable device and a UI element corresponding to context information of a wearable device.

### THE BRIEF DESCRIPTION OF THE DRAWINGS

FIG. 1 is a system diagram of a communication system according to an example embodiment;

FIG. 2 is a block diagram briefly illustrating a configuration of a server according to an example embodiment;

FIG. 3 is a block diagram briefly illustrating a configuration of a wearable device according to an example embodiment;

FIG. 4 is a block diagram briefly illustrating a configuration of a user terminal according to an example embodiment;

FIGS. 5 to 13C are diagrams illustrating various examples of obtaining context information and providing a UI element which corresponds to the context information according to an example embodiment;

FIG. 14 is a flowchart illustrating a control method of a server according to an example embodiment; and

FIG. 15 is a sequence diagram illustrating a control method of a communication system according to an example embodiment.

### DETAILED DESCRIPTION OF EXAMPLE EMBODIMENTS

Before describing example embodiments specifically, the terms used in the example embodiments will be described briefly.

With respect to the terms used in an example embodiment of the disclosure, general terms currently and widely used are selected in view of function with respect to the disclosure. However, the terms may vary according to an intention of a technician practicing in the pertinent art, an advent of new technology, etc. In specific cases, terms may be chosen arbitrarily, and in this case, definitions thereof will be described in the description of the corresponding disclosure. Accordingly, the terms used in the description should not necessarily be construed as simple names of the terms, but be defined based on meanings of the terms and overall contents of the present disclosure.

The terms including ordinal number such as “first,” “second,” and so on may be used in the description and the claims to distinguish the elements from one another. These terms are used only for the purpose of differentiating one component from another, without limitation thereto. For example, the first element may be named the second element without departing from the scope of right of the various example embodiments of the present disclosure, and similarly, the second element may be named the first element. The term “and/or” includes a combination of a plurality of described relevant items or any item of a plurality of described relevant items.

A singular term includes a plural form unless otherwise indicated.

The terms, “include,” “comprise,” “is configured to,” etc. of the description are used to indicate the presence of features, numbers, steps, operations, elements, parts or combination thereof, and do not exclude the possibilities of combination or addition of one or more features, numbers, steps, operations, elements, parts or combination thereof.

In an example embodiment, ‘a module’ or ‘a unit’ performs at least one function or operation, and may be realized as hardware, software, or combination thereof. Further, except the “modules” or “units” that have to be implemented by certain hardware, a plurality of “modules” or a plurality of “units” may be integrated into at least one module and realized as at least one processor (not illustrated).

In the example embodiments, in the case where a certain part is “connected” to the other part, it may include not only the case where the part is “directly connected” to the other part, but also the case where the part is “electrically connected” to the other part with another element interposed therebetween.

Also, in the example embodiments, a user input may include at least one of a touch input, a bending input, a voice input, a button input, and a multimodal input, but is not limited thereto.

In the example embodiments, the term “application” may refer to a set of computer programs designed to perform a specific function. There could be a variety of application in the example embodiments. For example, an application may be a game application, a video reproduction application, a map application, a memo application, a calendar application, a phone book application, a broadcasting application, an exercise support application, a payment application, a photo folder application, or the like, but is not limited thereto.

All the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having ideal or exaggerated meanings unless they are clearly defined in the various example embodiments.

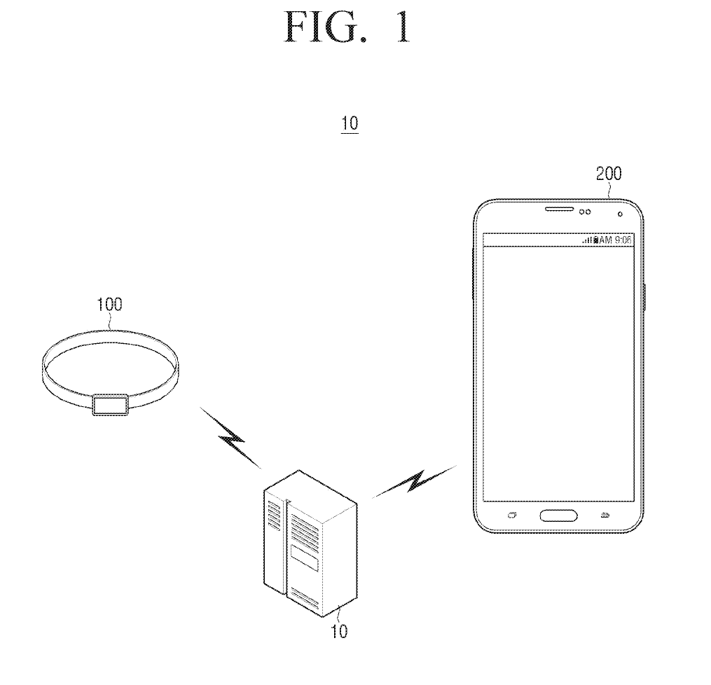

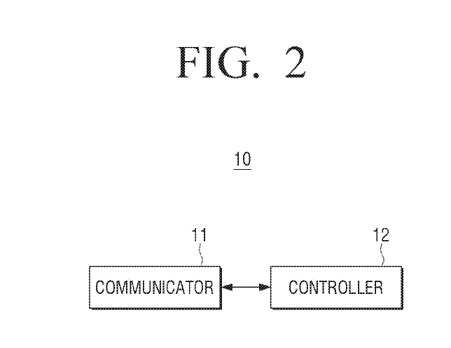

Hereinafter, the example embodiments will be described in detail with reference to the accompanying drawings. FIG. 1 is a diagram illustrating a configuration of a communication system in accordance with an example embodiment. As illustrated in FIG. 1, the communication system 1000 may include a server 10, a wearable device 100 and a user terminal 200. According to an example embodiment, the user terminal 200 may be implemented as a smartphone, but is not limited thereto. The user terminal 200 may be implemented as various electronic apparatuses such as a smart TV, a desktop PC, a tablet PC, a laptop PC, a navigation, etc.

The wearable device 100 may obtain data via near-field wireless communication. The wearable device 100 may receive beacon data via near-field wireless communication based on Bluetooth 4.0 (BLE) protocol from at least one of a plurality of beacon devices.

The wearable device 100 may transmit to the server 10 the data received via near-field wireless communication. When data is received via near-field wireless communication, the wearable device 100 may transmit to the server 10 the received data, and accordingly, the wearable device 100 may transmit data in real time.

The server 10 may receive the data transmitted from the wearable device 100. The server 10 may obtain context information of the wearable device 100 using the received data. Also, the server 10 may generate a UI element which corresponds to the obtained context information of the wearable device 100. The context information of the wearable device 100 may be the situation information such as the position information of the wearable device 100, the information of the time for which the wearable device 100 stays in a certain area, etc.

The server 10 may transmit the context information of the wearable device 100 and the UI element to the user terminal 200.

The user terminal 200 may display the received context information and the UI element.

As described above, as the user terminal 200 displays the context information of the wearable device 100 and the UI corresponding to the context information, a user may communicate with a subject of the wearable device 100.

It has been described that the wearable device 100 obtains data via near-field wireless communication, but the example embodiments are not limited thereto. The wearable device 100 may receive a voice signal via a voice input unit, and the server 10 may generate a UI element corresponding to a voice signal.

FIG. 2 is a diagram illustrating a configuration of the server 10 in accordance with an example embodiment. As illustrated in FIG. 2, the server 10 may include the communicator 11 and the controller 12.

The communicator 11 may communicate with an external device. The communicator 11 may receive from the wearable device 100 the data which the wearable device 100 obtains via near-field wireless communication, and transmit to the user terminal 200 the context information of the wearable device 100 and the UI element corresponding to the context information.

The controller 12 may control overall operations of the server 10. The controller 12 may obtain the context information of the wearable device 100 using data received via the communicator 11, and generate the UI element corresponding to the obtained context information of the wearable device 100. The controller 12 may control the communicator 11 to transmit to the user terminal 200 the context information of the wearable device 100 and the UI element.

The controller 12 may obtain the context information of the wearable device 100 using the data received via the communicator 11. The controller 120 may obtain the position information which indicates a current position of the wearable device 100 or the position in which the wearable device 100 stays or the time information which indicates the time for which the wearable device 100 stays in a certain position, etc. using the data received via the communicator 11. The controller 12 may control the communicator 11 to receive a voice signal, and obtain the context information of the wearable device 100 using the received voice signal.

If the obtained context information of the wearable device 100 satisfies a predetermined condition, the controller 12 may transmit a certain command to the wearable device 100. For example, if it appears that the obtained context information of the wearable device 100 is positioned in a predetermined area or that the wearable device 100 is positioned in the same area for a predetermined period of time or more, the controller 12 may control the communicator 11 to transmit to the user terminal 200 a command for connecting a video call to the user terminal 200.

The controller 12 may generate a UI element corresponding to the obtained context information of the wearable device 100. For example, if the context information of the wearable device 100 indicates that the wearable device 100 stays around a front door for 30 minutes or more, the controller 12 may control the communicator 11 to transmit to the user terminal 200 a photo of a pet including subtitles such as “Your pet is waiting for you.”

The controller 12 may generate the UI element which indicates the data accumulated for a certain period of time using the context information of the wearable device 100. For example, the controller 12 may generate a graph which shows the data indicating that, for instance, a voice signal was input two times from 9 AM to 10 AM, and a voice signal was not input from 10 AM to 11 AM, etc.

The controller 12 may control the communicator 11 to transmit to the user terminal 200 the context information of the wearable device 100 and the UI element corresponding to the context information. The controller 12 may control the communicator 11 to transmit to the user terminal the context information of the wearable device 100 and the UI element only if the context information of the wearable device 100 satisfies a predetermined condition. For example, if it appears that the obtained context information of the wearable device 100 is positioned in a predetermined area or that the wearable device 100 is positioned in the same area for a predetermined period of time or more, the controller 12 may control the communicator 11 to transmit to the user terminal 200 the context information of the wearable device 100 and the UI element.

The controller 12 may control the communicator 11 to receive from the user terminal 200 a user command for controlling the wearable device 100 or at least one of cameras. The controller 12 may control the communicator 11 to transmit to the wearable device 100 the received user command for controlling the wearable device 100 or at least one of cameras.

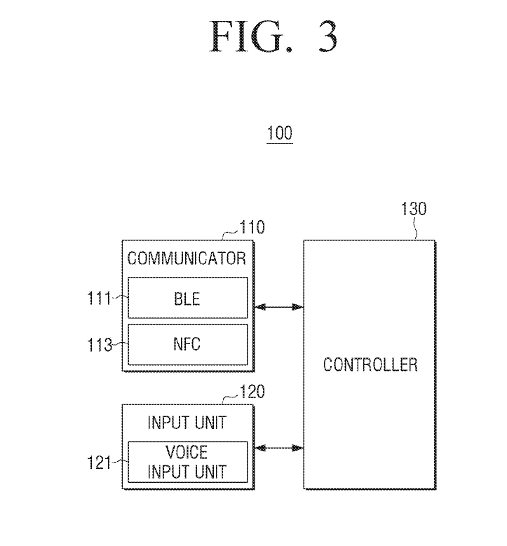

FIG. 3 is a diagram illustrating a configuration of the wearable device 100 in accordance with an example embodiment. As illustrated in FIG. 3, the wearable device 100 may include a communicator 110, an input unit 120, and a controller 130. The communicator 110 may include a BLE 111, an NFC 113, etc. and the input unit 120 may include a voice input unit 121. The wearable device 100 may be implemented as various types of electronic devices such as a smart watch, a smart glasses, etc. which have an appropriate shape depending on different wearing methods. The example of the wearable device having a shape of a leash of a pet such as a puppy will be described below.

The communicator 110 may communicate with an external device. The communicator 110 may transmit the data obtained via near-field wireless communication to the server 10, and receive a user command for controlling the wearable device 100.

The communicator 110 may obtain the data via near-field wireless communication. The communicator 110 may receive a beacon signal from at least one of a plurality of beacon devices. Generally, a beacon signal relates to a wireless communication technique such as an infrared communication or an RF communication, and may be used in a short distance communication performed within a distance of 70 m or less. In the example embodiment, the data obtained using the beacon signal may be referred to as ‘beacon data.’ The communicator 110 may use a beacon device which performs a unidirectional communication or a bidirectional communication. In the example embodiment, however, if the wearable device 100 is within an area in which the beacon data is able to be received by using the beacon device which performs a unidirectional communication, the communicator 110 may receive the beacon data.

According to various example embodiments, the communicator 110 may use NFC communication for transmission and reception of data between terminals positioned in a close distance of 10 cm or less from each other by non-contact near-field wireless communication which uses the frequency band of 13.56 MHz.

The communicator 110 may transmit beacon data to the server 10 and receive a user command for controlling the wearable device 100. The communicator 110 may include a Wi-Fi chip, a Bluetooth chip, an NFC chip, a wireless communication chip or the like. The Wi-Fi chip, the Bluetooth chip and the NFC chip may communicate by a Wi-Fi method, a Bluetooth method, and an NFC method, respectively. The NFC chip may refer to the chip which operates by a near field communication (NFC) method which uses a frequency band of 13.56 MHz from among various RF-ID frequency bands such as 135 kHz, 13.56 MHz, 433 MHz, 860-960 MHz, 2.45 GHz, or the like. When using the Wi-Fi chip or Bluetooth-chip, various connection information such as an SSID, a session key, etc., may be firstly transmitted and received, communication connection may be performed using the information, and various information may be transmitted and received. The wireless communication chip may refer to the chip which communicates according to various communication protocols, such as IEEE, ZigBee, 3rd Generation (3G), 3rd Generation Partnership (3GP), Long Term Evolution (LTE), or the like.

The input unit 120 may receive a user command for controlling the wearable device 100. The input unit 120 may include various input devices for receiving a user input, such as a touch input unit, a button, a voice input unit 121, a motion input unit, a keyboard, a mouse, etc. The input unit 120 may receive a voice signal via the voice input unit 121.

The controller 130 may control overall operations of the wearable device 100. The controller 130 may control the communicator 110 to receive data via near-field wireless communication. The controller 130 may control the communicator 110 to transmit to the server 10 the received data via near-field wireless communication.

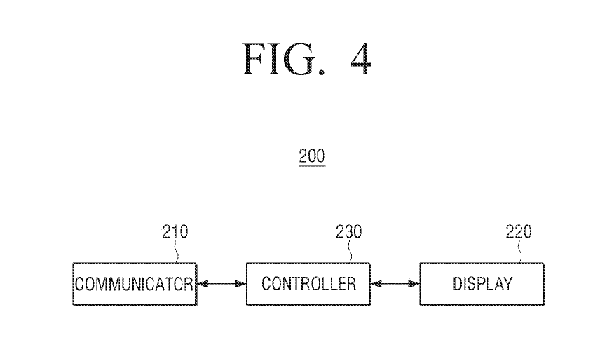

FIG. 4 is a diagram illustrating a configuration of the user terminal 200 in accordance with an example embodiment. As illustrated in FIG. 4, the user terminal 200 may include the communicator 210, the display 220 and the controller 230. According to an example embodiment, the user terminal 200 may be implemented as various types of electronic apparatuses such as a smart phone, a smart watch, a smart glasses, a tablet PC, a laptop, etc.

The communicator 210 may communicate with various types of external devices in accordance with various types of communication methods. The communicator 210 may include various communication chips such as a Wi-Fi chip, a Bluetooth chip, an NFC chip, a wireless communication chip or the like. The Wi-Fi chip, the Bluetooth chip and the NFC chip may communicate by a Wi-Fi method, a Bluetooth method, and an NFC method, respectively. The NFC chip may refer to the chip which operates by a near field communication (NFC) method which uses a frequency band of 13.56 MHz from among various RF-ID frequency bands such as 135 kHz, 13.56 MHz, 433 MHz, 860-960 MHz, 2.45 GHz, or the like. When using the Wi-Fi chip or Bluetooth-chip, various connection information such as an SSID, a session key, etc., may be firstly transmitted and received, communication connection may be performed using the information, and various information may be transmitted and received. The wireless communication chip may refer to the chip which communicates according to various communication protocols, such as IEEE, ZigBee, 3rd Generation (3G), 3rd Generation Partnership (3GP), Long Term Evolution (LTE), or the like.

The communicator 210 may receive the context information of the wearable device 100 and the UI element from the server 10, and transmit to the server 10 a user command for controlling the wearable device 100.

The display 220 may display a video frame that is generated by processing of image data received from an image receiving unit (not illustrated) by an image processor (not illustrated) and at least one of the screens generated by a graphic processor (not illustrated). The display 220 may display a message window including a message which is transmitted to and received from an external device. At least one of a recommended image and a keyboard UI may be added to the message window, and the message window may be displayed on the display 220.

The context information and the UI element which are received from the server 10 via the communicator 210 may be displayed on the display 220 in accordance with a command of the controller 230.

The controller 230 may control overall operations of the user terminal 200 using various programs stored in the storage.

The controller 230 may include a RAM, a ROM, a graphic processor, a main CPU, a first to nth interfaces, and a bus. The RAM, the ROM, the graphic processor, the main CPU, the first to nth interfaces may be connected to one another via the bus.

The ROM may store a command word set, etc. for booting a system. Once power is supplied in response to an input of a turn-on command, the main CPU may copy the O/S stored in the storage to the RAM in response to a command word stored in the ROM, execute the O/S, and boot the system. Once the booting is completed, the main CPU may copy various application programs stored in the storage to the RAM, execute the application programs copied to the RAM and perform various operations.

The graphic processor may generate a screen including various objects such as an icon, an image, text, etc. using a calculation unit (not illustrated) and a rendering unit (not illustrated). The calculation unit may calculate an attribute value such as a coordinate value, a shape, a size, a color, etc. with which each object is displayed conforming to the layout of the screen based on a received control command. The rendering unit may generate a screen of a variety of layouts which includes an object based on the attribute value calculated by the calculation unit. The screen generated in the rendering unit may be displayed on a display area of the display 220.

The main CPU may access to the storage, and perform booting using an operating system (O/S) stored in the storage, and perform various operations using various programs stored in the storage.

The first to nth interfaces may be connected with various components described above. One of the interfaces may be a network interface which is connected with an external device via a network.

The controller 230 may control the display 220 to display the context information of the wearable device 100 received via the communicator 210 and the UI element which corresponds to the context information.

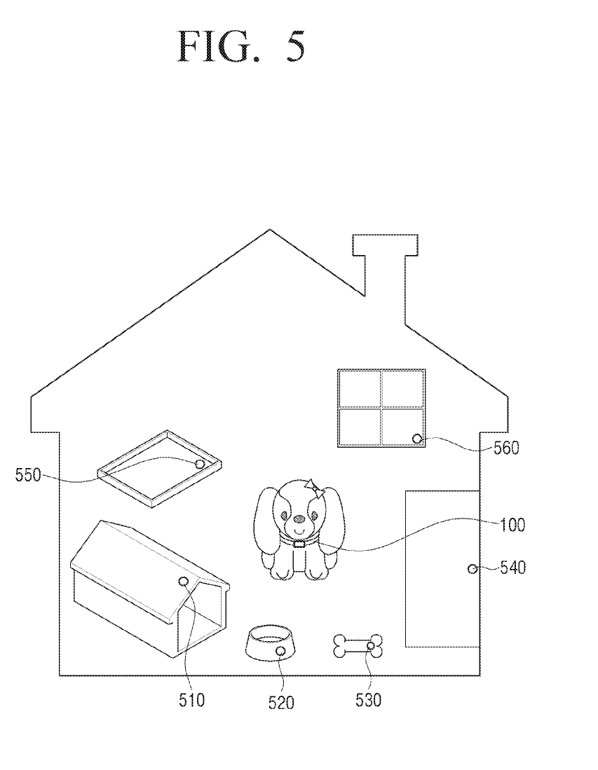

The method of the wearable device 100 for receiving beacon data will be described with reference to FIG. 5 in accordance with an example embodiment. The controller 130 may control the communicator 110 to transmit to the server 10 the obtained data via near-field wireless communication. For example, the controller 130 may control the communicator 110 to receive beacon data from at least one of a plurality of beacon devices 510, 520, 530, 540, 550, and 560. The controller 130 may control the communicator 110 to transmit to the server 10 the received beacon data.

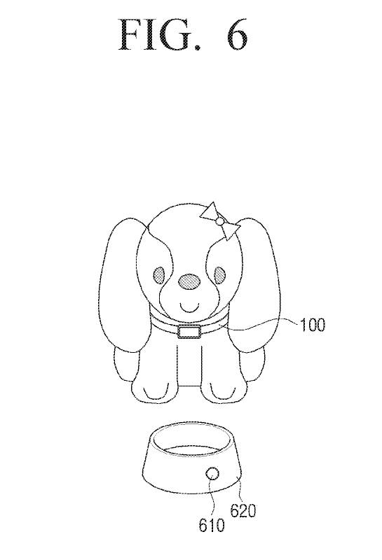

The method of the wearable device 100 for obtaining the context information and generating a UI element which corresponds to the obtained context information will be described with reference to FIGS. 6 to 15 below.

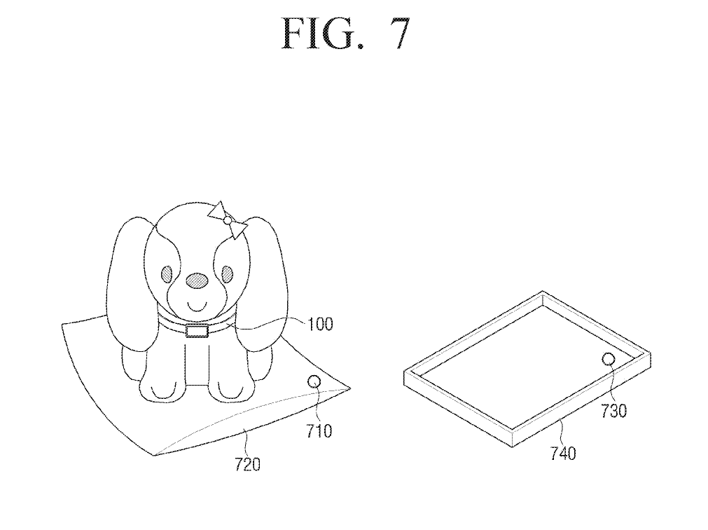

The controller 12 may control the communicator 11 to receive from the wearable device 100 the data which the wearable device 100 obtains via near-field wireless communication. As illustrated in FIG. 6, the data received via the communicator 11 is the data received from a beacon device 610 attached on a dog food bowl 620, the controller 230 may obtain the position information indicating that the wearable device 100 is positioned around the pet food bowl 620. Also, as illustrated in FIG. 7, if the data received via the communicator 11 is the data received from a beacon device 720 of the wearable device 100 attached on a dot sitting mat 720, the controller 230 may obtain the position information that the wearable device 100 is positioned around the dog sitting mat 720. If the data received via the communicator 11 is the data received from a beacon device 740 of the wearable device 100 attached on a dog toilet 740, the controller 12 may obtain the position information that the wearable device 100 is positioned around the dog toilet 740.

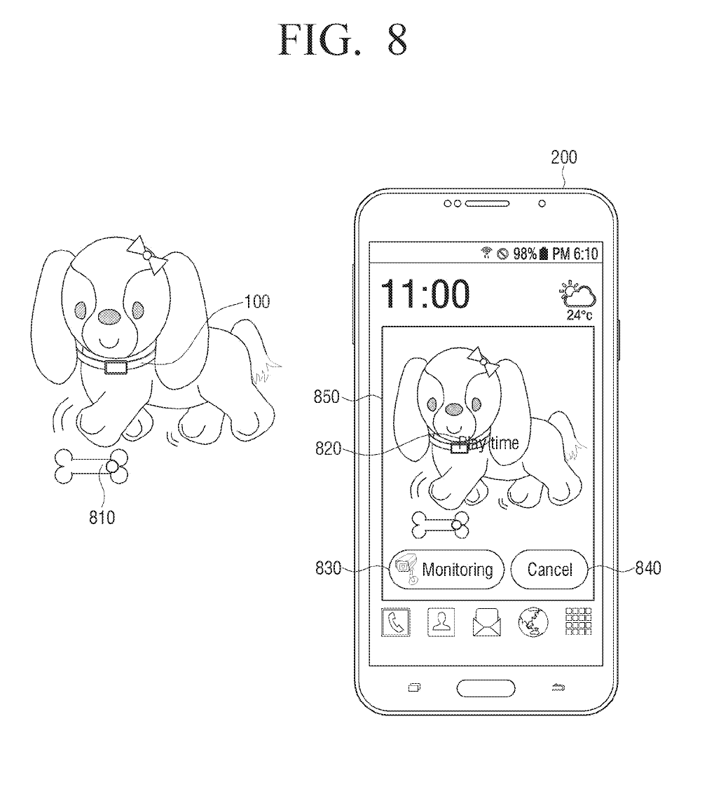

As illustrated in FIG. 8, if the data received via the communicator 11 is the data received from a beacon device 810 attached on a dog toy 810, the controller 12 may obtain the position information that the wearable device 100 is positioned around the dog toy 810. The controller 12 may also generate a UI element 850 corresponding to the position information indicating that the wearable device 100 is positioned around the dog toy 810. As the UI element 850 is positioned around the dog toy 810, the UI element 850 may include a ‘play time 820’ which informs that the dog which is an object of the wearable device 100 is currently playing.

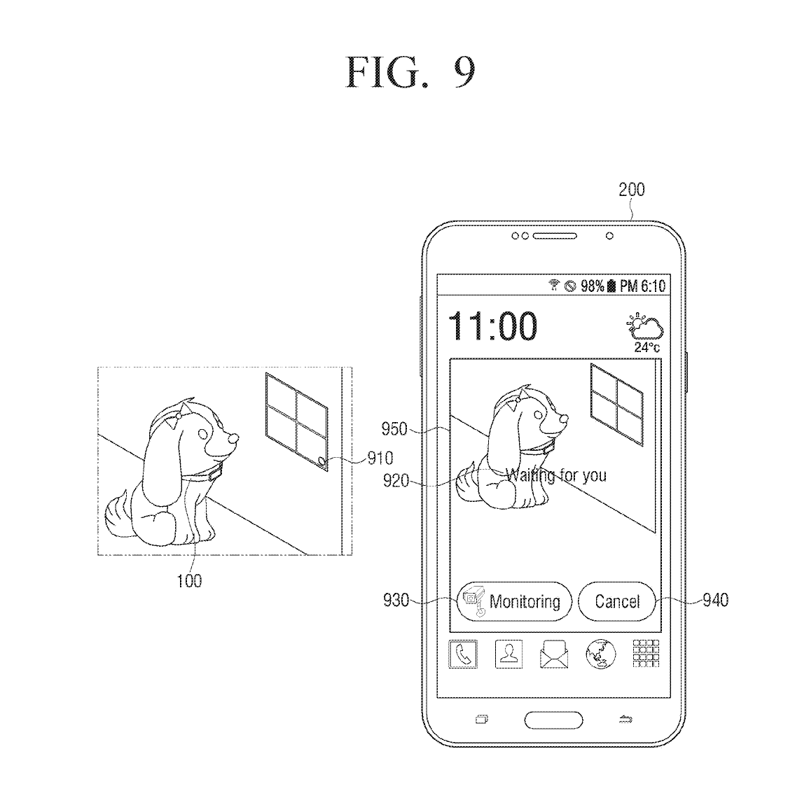

As another example, as illustrated in FIG. 9, if the data received via the communicator 11 is the data received from a beacon device 910 attached on the window, the controller 12 may obtain the information that the wearable device 100 is positioned around the window 910. The controller 12 may generate a UI element 950 corresponding to the position information indicating that the wearable device 100 is positioned around the window 810. As the wearable device 100 is positioned around the window 810, the UI element 950 may include a ‘waiting for you (820)’ which informs that the dog which is an object of the wearable device 100 is waiting for the owner.

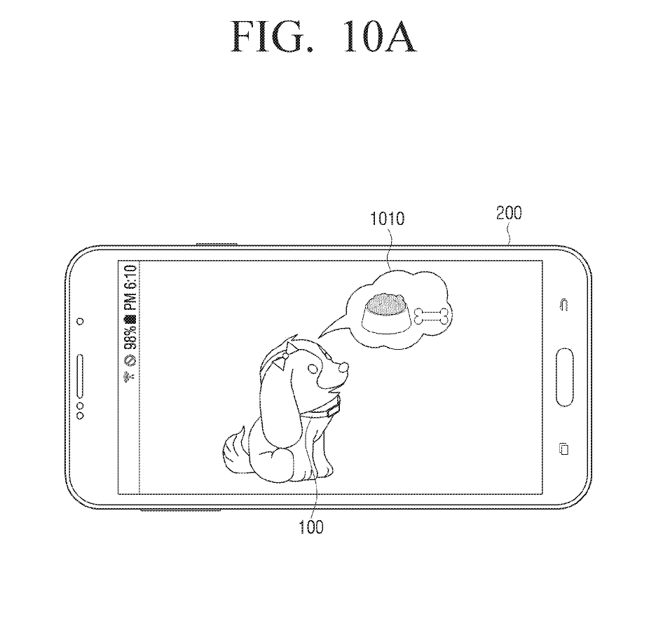

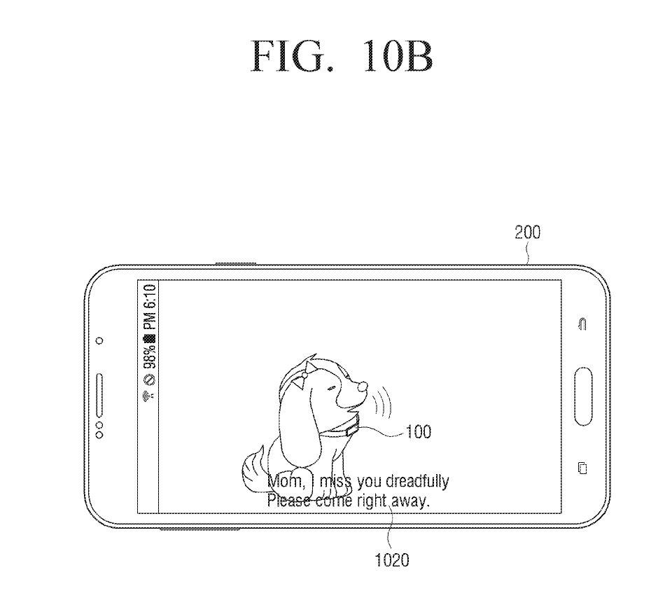

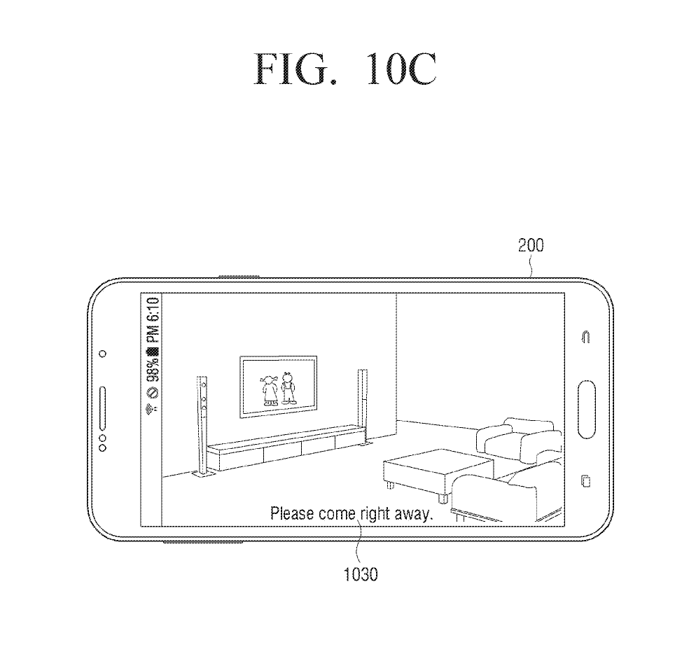

FIGS. 10A to 10C are diagrams illustrating the method of the controller 12 for generating the context information corresponding to the wearable device 100 in accordance with various example embodiments.

For example, as illustrated in FIG. 10A, if it is determined that the data received via the communicator 11 is the data which is obtained from the beacon device attached on the dog food bowl five time or more within thirty minutes, the controller 12 may generate a dog food 1010 as the UI element based on the determination that the dog the object of the wearable device 100 is hungry.

As another example, as illustrated in FIG. 10B, if it is determined that the voice signal received via the communicator 11 is a howling, the controller 12 may generate a photo of the dog as the UI element including the text “Mom, miss you dreadfully. Please come right away 1020” based on the determination that the dog is missing the owner.

As another example, as illustrated in FIG. 10C, if the context information that the dog stays around the beacon device attached on the front door is obtained using the data received via the communicator 11, the controller 12 may generate the UI element including the text “Please come right away” 1030.

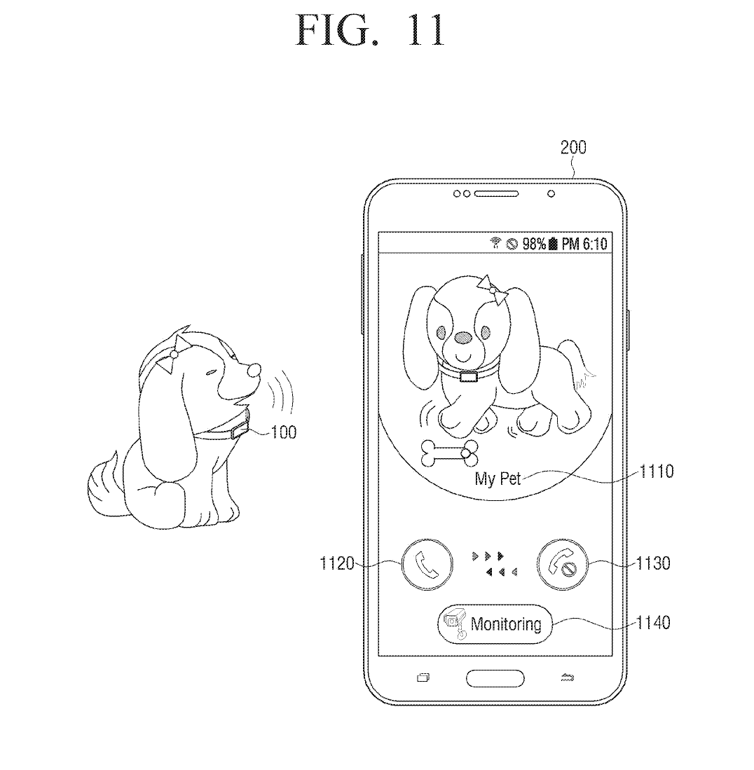

If the context information obtained using the data received via the communicator 11 satisfies a predetermined condition, the controller 12 may control the communicator 11 to transmit a certain command to the wearable device 100. For example, as illustrated in FIG. 11, if it is determined that the context information obtained using a voice signal received via the communicator 11 indicates that the dog barked 10 times or more within thirty minutes, the controller 12 may control the communicator 11 to transmit to the wearable device 100 a user command for connecting a video call 1120 and 1130.

If a certain event occurs, the controller 12 may control the communicator 11 to transmit the obtained context information of the wearable device 100 and the UI element to the user terminal 200. For example, if the command for requesting the context information and the UI element is received from the user terminal 200 via the communicator 11, the controller 12 may control the communicator 11 to transmit the context information of the wearable device 100 and the UI element to the user terminal 200.

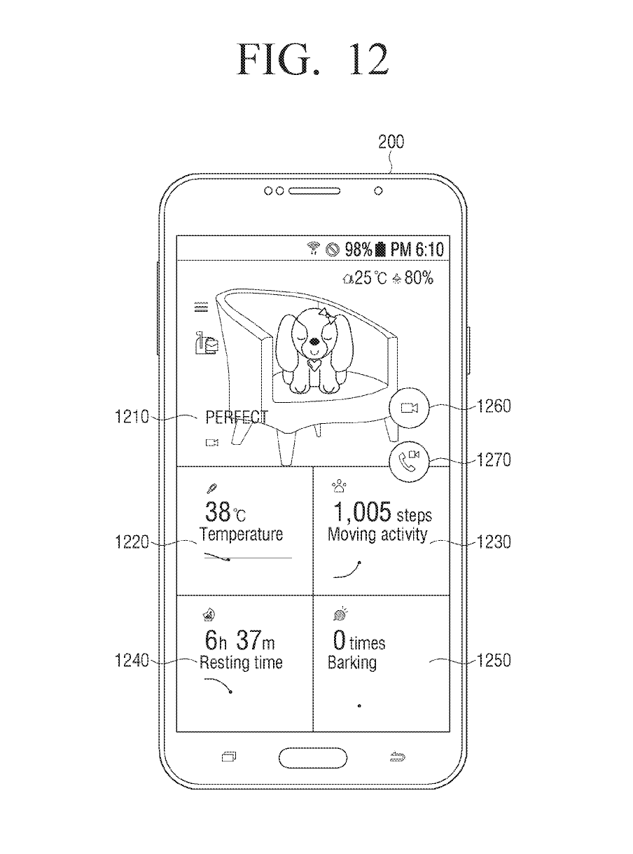

If a user command for executing a communication application from the user terminal 200 via the communicator 11, the controller 12 may control the communicator 11 to transmit the context information of the wearable device 100 and the UI element to the user terminal 200. As illustrated in FIG. 12, the UI element may include a perfect 1210 which indicates the overall state of the dog the object of the wearable device 100, an icon 1220 which indicates the temperature of the dog, an icon 1230 which indicates the movement of the dog, an icon 1240 which indicates the resting time of the dog, an icon 1240 which indicates how many times the dog barks, a camera monitoring icon 1260, and a video call icon 1270.

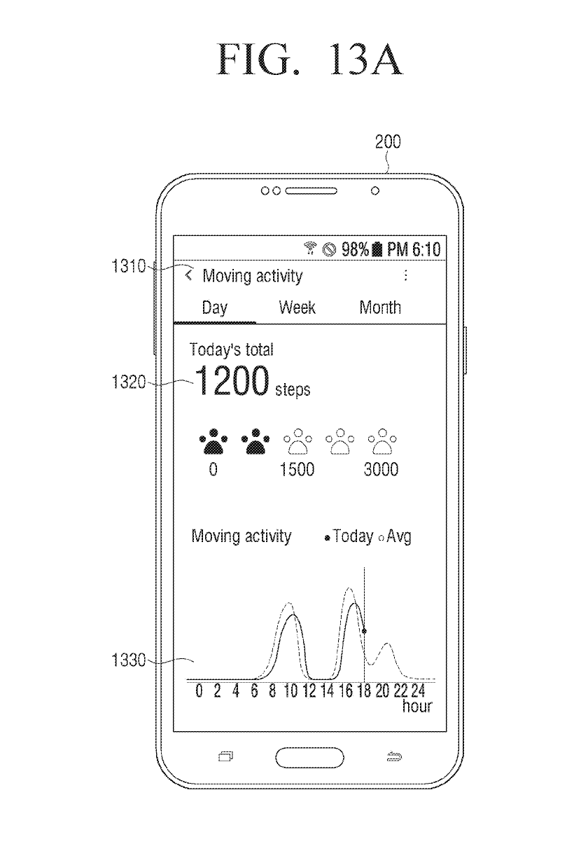

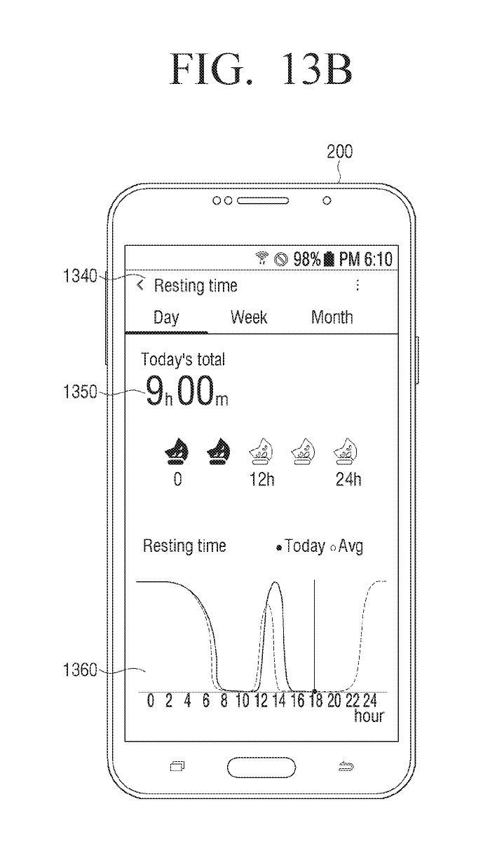

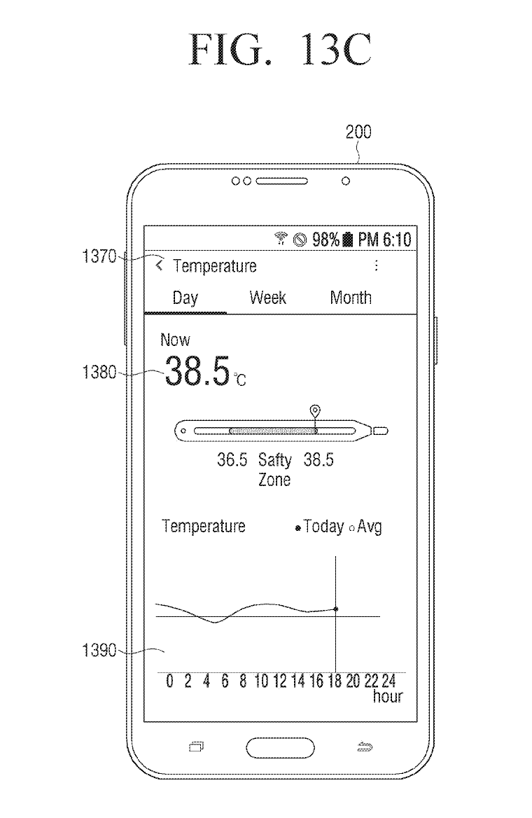

If a user command that a user selects the icon 1230 which indicates the movement of the dog is received via the communicator 11, the controller 12 may generate the UI element as illustrated in FIG. 13A. Also, if the user command for selecting the icon 1240 which indicates the resting time of the dog is received via the communicator 11, the controller 12 may generate the UI element as illustrated in FIG. 13B. Also, if a user command for selecting the icon 1220 which indicates the temperature of the dog via the communicator 11, the controller 12 may generate the UI element as illustrated in FIG. 13C.

For example, referring to FIG. 13A, a moving activity 1310 which is the UI element indicating the movement of the dog, a 1200—steps 1320 which indicates the number of steps of the dog during a day, and a graph 1330 which indicates the movement over time may be included.

It has been described that the server 10 obtains the context information of the wearable device 100 using the received data, and that the UI element which corresponds to the context information is generated, but the example embodiments are not limited thereto. For example, the user terminal 200 may also receive data from the wearable device 100, obtain the context information of the wearable device 100 using the received data, and generate the UI element which corresponds to the context information. Also, the wearable device 100 may also obtain the context information using the received data using near-field wireless communication.

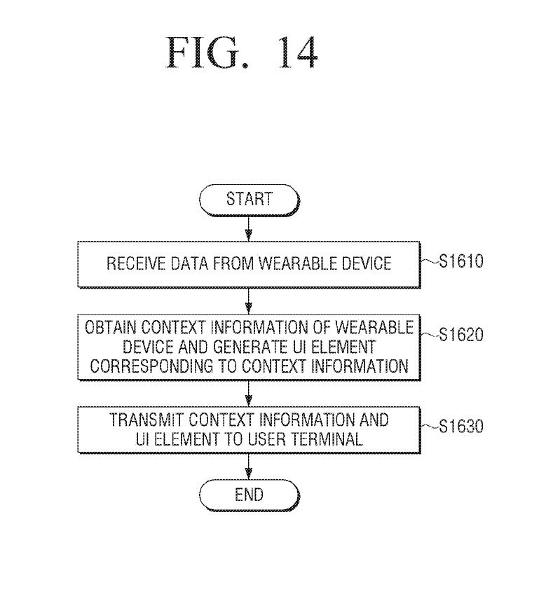

The method of the server 10 will be described with reference to FIG. 14 below in accordance with an example embodiment.

The server 10 may receive from the wearable device 100 the data which the wearable device 100 obtains via near-field wireless communication (S1610). The server 10 may receive from the wearable device 100 a voice signal input via the voice input unit.

The server 10 may obtain the context information of the wearable device 100 using the received data, and generate the UI element corresponding to the obtained context information (S1620).

The server 10 may transmit the context information of the wearable device 100 and the UI element to the user terminal 200 (S1630).

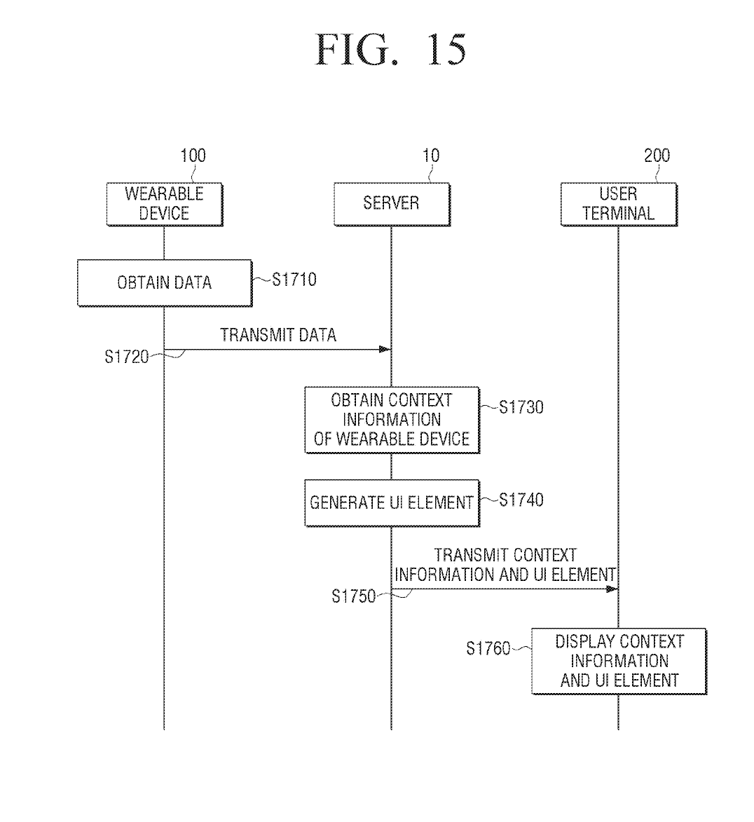

The control method of the communication system 1000 will be described with reference to FIG. 15 in accordance with an example embodiment.

The wearable device 100 may obtain data via near-field wireless communication (S1710). The wearable device 100 may receive beacon data via near-field wireless communication based on Bluetooth 4.0 (BLE) from at least one of a plurality of beacon devices.

The wearable device 100 may transmit the data received via near-field wireless communication to the server 10. When the data is received via near-field wireless communication, the wearable device 100 may transmit to the server 10 the received data (S1720).

The server 10 may receive the data transmitted from the wearable device 100. The server 10 may obtain the context information of the wearable device 100 using the received data (S1730).

The server 10 may generate the UI element which corresponds to the obtained context information of the wearable device 100 (S1740). The context information of the wearable device 100 may be the situation information such as the position information of the wearable device 100, the information of the time for which the wearable device 100 stays in a certain area, etc.

The server 10 may transmit the context information of the wearable device 100 and the UI element to the user terminal 200 (S1750).

The user terminal 200 may display the received context information and the UI element (S1760).

As illustrated above, a user may communicate with a subject of the wearable device as the user terminal 200 displays the context information of the wearable device 100 and the UI corresponding to the context information.

The methods described above in the various example embodiments may write a program executable in a computer and be embodied in a universal digital computer which executes the program using a computer readable recording medium. The structure of data used in the aforementioned method may be recorded in the computer readable recording medium by various means. The computer readable recording medium may include a storage medium such as a magnetic storage medium (e.g., a ROM, a floppy disk, a hard disk, etc.), an optical reading medium (e.g., a CD-ROM, a DVD, etc.), or the like.

The foregoing example embodiments and advantages are merely examples and are not to be construed as limiting the example embodiments. The description of the example embodiments is intended to be illustrative, and not to limit the scope of the disclosure, as defined by the appended claims, and many alternatives, modifications, and variations will be apparent to those skilled in the art.

What is claimed is:

1. A control method of a server, the method comprising:
receiving data which a wearable device obtains via near-field communication, from the wearable device;
obtaining context information of the wearable device using the received data and generating a UI element corresponding to the context information of the wearable device; and
transmitting the context information of the wearable device and the UI element to a user terminal.

2. The method of claim 1, wherein the generating a UI element comprises obtaining position information of the wearable device and information regarding time for which the wearable device stays in the position using the received data, and generating a UI element corresponding to the position information and the time information.

3. The method of claim 1, wherein a certain command is transmitted to the wearable device in response to the obtained context information of the wearable device satisfying a predetermined condition.

4. The method of claim 2, wherein the transmitting a certain command comprises transmitting to the wearable device a command for connecting a video call to the user terminal in response to the wearable device being positioned in a predetermined area or being positioned in a same area for a predetermined period of time or more.

5. The method of claim 1, further comprising:
receiving a user command for controlling at least one of the wearable device and a camera from the user terminal; and
transmitting the user command to the wearable device.

6. The method of claim 1, wherein the generating a UI element comprises obtaining context information of the wearable device and generating a UI element which accumulates the context information for a predetermined period of time and indicates the accumulated context information.

7. The method of claim 1, wherein the receiving comprises receiving a voice signal input in the wearable device from the wearable device, and the generating a UI element comprises obtaining context information of the wearable device using the received voice signal and generating a UI element corresponding to the context information of the wearable device.

8. The method of claim 1, wherein the transmitting comprises transmitting the obtained context information of the wearable device and the UI element to the user terminal in response to the obtained context information of the wearable device satisfying a predetermined condition.

9. A server comprising:
a communicator configured to communicate with a wearable device and a user terminal; and
a controller configured to:
control the communicator to receive data which the wearable device obtains via near-field wireless communication, from the wearable device,
obtain context information of the wearable device using the received data and generate a UI element corresponding to the context information of the wearable device, and
control the communicator to transmit the context information of the wearable device and the UI element to the user terminal.

10. The server of claim 9, wherein the controller obtains position information of the wearable device and information regarding time for which the wearable device stays in the position using the received data.

11. The server of claim 9, wherein the controller controls the communicator to transmit a certain command to the wearable device in response to the obtained context information of the wearable device satisfying a predetermined condition.

12. The server of claim 11, wherein the controller controls the communicator to transmit to the wearable device a command for connecting a video call to the user terminal in response to the wearable device being positioned in a predetermined area or being positioned in a same area for a predetermined period of time or more.

13. The server of claim 9, wherein the controller controls the communicator to receive a user command for controlling at least one of the wearable device and a camera from the user terminal and to transmit the user command to the wearable device.

14. The server of claim 9, wherein the controller obtains context information of the wearable device and generates a UI element which accumulates the context information for a predetermined period of time and indicates the accumulated context information.

15. The server of claim 9, wherein the controller receives a voice signal input in the wearable device from the wearable device, obtains the context information of the wearable device using the received voice signal, and generates a UI element corresponding to the context information of the wearable device.
